(19) United States
(12) Patent Application Publication
(10) Pub. No.: US 2011/0052473 A1
(43) Pub. Date: Mar. 3, 2011

(54) METHOD OF MANUFACTURING ACTIVE MATERIAL

(75) Inventors: Atsushi SANO, Tokyo (JP); Keitaro OTSUKI, Tokyo (JP); Yosuke MIYAKI, Tokyo (JP); Takeshi TAKAHASHI, Tokyo (JP); Akiji HIGUCHI, Kyoto-shi (JP)

(73) Assignee: TDK CORPORATION, Tokyo (JP)

(21) Appl. No.: 12/854,572

(22) Filed: Aug. 11, 2010

(30) Foreign Application Priority Data
Aug. 25, 2009 (JP) P2009-194575
Aug. 25, 2009 (JP) P2009-194580

(51) Int. Cl. C01B 25/30

(52) U.S. Cl. 423/306

(57) ABSTRACT

Methods of manufacturing an active material capable of improving the discharge capacity of a lithium-ion secondary battery are provided. The first method of manufacturing an active material comprises a hydrothermal synthesis step of heating a mixture containing a lithium source, a phosphate source, a vanadium source, water, and a reducing agent to 100 to 195° C. under pressure; and a heat treatment step of heating the mixture to 500 to 700° C. after the hydrothermal synthesis step. The hydrothermal synthesis step adjusts the ratio [P]/[V] of the number of moles of phosphorus [P] contained in the mixture before heating to the number of moles of vanadium [V] contained in the mixture before heating to 0.9 to 1.2. The second method of manufacturing an active material comprises a hydrothermal synthesis step of heating a mixture containing a lithium source, a phosphate source, a vanadium source, water, and a reducing agent to 200 to 300° C. under pressure and adjusts the ratio [P]/[V] of the number of moles of phosphorus [P] contained in the mixture before heating to the number of moles of vanadium [V] contained in the mixture before heating to 0.9 to 1.5.

### BACKGROUND OF THE INVENTION

1. Field of the Invention

The present invention relates to a method of manufacturing an active material.

2. Related Background Art

Laminar compounds such as LiCoO₂ and LiNi_{1/3}Mn_{1/3}Co_{1/3}O₂ and spinel compounds such as LiMn₂O₄ have conventionally been used as positive electrode materials (positive electrode active materials) of lithium-ion secondary batteries. Attention has recently been focused on compounds having olivine-type structures such as LiFePO₄. Positive electrode materials having the olivine structure have been known to exhibit high thermal stability at high temperature, thereby yielding high safety. However, lithium-ion secondary batteries using LiFePO₄ have drawbacks in that their charge/discharge voltage is low, i.e., about 3.5 V, whereby their energy density decreases. Therefore, LiCoPO₄, LiNiPO₄, and the like have been proposed as phosphate-based positive electrode materials which can achieve high charge/discharge voltage. Nevertheless, lithium-ion secondary batteries using these positive electrode materials have not attained sufficient capacities yet. Among the phosphate-based positive electrode materials, LiVOPO₄ has been known as a compound which can achieve a 4-V-class charge/discharge voltage. However, lithium-ion secondary batteries using LiVOPO₄ have not attained sufficient reversible capacity and rate characteristic yet, either. The above-mentioned positive electrode materials are described, for example, in Japanese Patent Application Laid-Open Nos. 2003-68304 and 2004-303527; J. Solid State Chem., 95, 352 (1991); N. Dupre et al., Solid State Ionics, 140, pp. 209-221 (2001); N. Dupre et al., J. Power Sources, 97-98, pp. 532-534 (2001); J. Baker et al., J. Electrochem. Soc., 151, A796 (2004); and Electrochemistry, 71, 1108 (2003). In the following, a lithium-ion secondary battery will be referred to as “battery” as the case may be.

### SUMMARY OF THE INVENTION

In view of the problems of the prior art mentioned above, it is an object of the present invention to provide a method of manufacturing an active material which can improve the discharge capacity of a lithium-ion secondary battery.

First Aspect of Invention

For achieving the above-mentioned object, the method of manufacturing an active material in accordance with the first aspect of the present invention comprises a hydrothermal synthesis step of heating a mixture containing a lithium source, a phosphate source, a vanadium source, water, and a reducing agent to 100 to 195° C. under pressure and a heat treatment step of heating the mixture to 500 to 700° C. after the hydrothermal synthesis step. In the first aspect of the present invention, the hydrothermal synthesis step adjusts the ratio [P]/[V] of the number of moles of phosphorus [P] contained in the mixture before heating to the number of moles of vanadium [V] contained in the mixture before heating to 0.9 to 1.2. In the following, the first aspect of the present invention will be referred to as “first aspect”.

The first aspect makes it possible to yield LiVOPO₄. A lithium-ion secondary battery having LiVOPO₄ obtained by the first aspect as a positive electrode active material can improve the discharge capacity as compared with a lithium-ion secondary battery using LiVOPO₄ obtained by a conventional manufacturing method.

In the first aspect, the hydrothermal step may adjust the ratio [Li]/[V] of the number of moles of lithium [Li] contained in the mixture before heating to [V] to 0.9 to 1.2. Effects of the first aspect can also be obtained when [Li]/[V] is greater than 1.2, though.

Preferably, in the first aspect, the reducing agent is hydrazine. A lithium-ion secondary battery having LiVOPO₄ obtained by using hydrazine improves the discharge capacity and rate characteristic as compared with a lithium-ion secondary battery having LiVOPO₄ obtained by using hydrogen peroxide as the reducing agent.

Second Aspect of Invention

For achieving the above-mentioned object, the method of manufacturing an active material in accordance with the second aspect of the present invention comprises a hydrothermal synthesis step of heating a mixture containing a lithium source, a phosphate source, a vanadium source, water, and a reducing agent to 200 to 300° C. under pressure. In the second aspect of the present invention, the hydrothermal synthesis step adjusts the ratio [P]/[V] of the number of moles of phosphorus [P] contained in the mixture before heating to the number of moles of vanadium [V] contained in the mixture before heating to 0.9 to 1.5. In the following, the second aspect of the present invention will be referred to as “second aspect”.

The second aspect makes it possible to yield LiVOPO₄. A lithium-ion secondary battery having LiVOPO₄ obtained by the second aspect as a positive electrode active material can improve the discharge capacity as compared with a lithium-ion secondary battery using LiVOPO₄ obtained by a conventional manufacturing method.

In the second aspect, the hydrothermal step may adjust the ratio [Li]/[V] of the number of moles of lithium [Li] contained in the mixture before heating to [V] to 0.9 to 1.5. Effects of the second aspect can also be obtained when [Li]/[V] is greater than 1.5, though.

Preferably, in the second aspect, the lithium source is at least one species selected from the group consisting of LiOH, Li₂CO₃, CH₃COOLi, and Li₃PO₄. A lithium-ion secondary battery having LiVOPO₄ obtained by using any of these lithium sources improves the discharge capacity and rate characteristic as compared with a lithium-ion secondary battery having LiVOPO₄ obtained by using Li₂SO₄ as a lithium source.

Preferably, the second aspect further comprises a heat treatment step of heating the mixture after the hydrothermal synthesis step. This can improve the rate characteristic of the lithium-ion secondary battery.

The first and second aspects can provide methods of manufacturing an active material which can improve the discharge capacity of a lithium-ion secondary battery.

### DESCRIPTION OF THE PREFERRED EMBODIMENTS

### Embodiment of First Aspect

In the following, the method of manufacturing an active material in accordance with an embodiment of the first aspect will be explained. This embodiment of the first aspect will be referred to as “first embodiment” hereinafter.

Hydrothermal Synthesis Step

The hydrothermal synthesis step initially puts a lithium source, a phosphate source, a vanadium source, water, and a reducing agent into a reaction vessel (e.g., an autoclave) having functions to heat and pressurize the inside thereof, so as to prepare a mixture (aqueous solution) in which they are dispersed. When preparing the mixture, for example, a mixture of the phosphate source, vanadium source, water, and reducing agent may be refluxed, and then the lithium source may be added thereto. This reflux can form a complex of the phosphate source and vanadium source.

As the lithium source, at least one species selected from the group consisting of LiNO₃, Li₂CO₃, LiOH, LiCl, Li₂SO₄, and CH₃COOLi can be used.

Preferably, the lithium source is at least one species selected from the group consisting of LiOH, Li₂CO₃, CH₃COOLi, and Li₃PO₄. This can improve the discharge capacity and rate characteristic of a battery as compared with the case using Li₂SO₄.

As the phosphate source, at least one species selected from the group consisting of H₃PO₄, NH₄H₂PO₄, (NH₄)₂HPO₄, and Li₃PO₄ can be used.

As the vanadium source, at least one species selected from the group consisting of V₂O₅ and NH₄VO₃ can be used.

Two or more species of the lithium source, two or more species of the phosphate source, or two or more species of the vanadium source may be used together.

As the reducing agent, at least one of hydrazine (NH₂NH₂.H₂O) and hydrogen peroxide (H₂O₂), for example, can be used. In particular, it is preferred for the first aspect to use hydrazine as the reducing agent. Using hydrazine tends to improve the discharge capacity and rate characteristic of a battery remarkably as compared with the cases using other reducing agents.

Before heating the mixture under pressure, the hydrothermal synthesis step of the first embodiment adjusts the ratio [P]/[V] of the number of moles of phosphorus [P] contained in the mixture to the number of moles of vanadium [V] contained in the mixture to 0.9 to 1.2. A battery obtained when adjusting [P]/[V] to the outside of the numeric range of 0.9 to 1.2 is hard to improve the discharge capacity. [P]/[V] may be adjusted by the compounding ratio between the phosphate source and vanadium source contained in the mixture.

Before heating the mixture under pressure, the hydrothermal synthesis step of the first embodiment may adjust the ratio [Li]/[V] of the number of moles of lithium [Li] contained in the mixture to [V] to 0.9 to 1.2. Effects of the first aspect can also be obtained when [Li]/[V] is greater than 1.2, though. [Li]/[V] may be adjusted by the compounding ratio between the lithium source and vanadium source contained in the mixture.

It has been necessary for conventional methods of manufacturing LiVOPO₄ to adjust [Li]/[V] to a value (e.g., 9) greater than 1 which is a stoichiometric ratio of LiVOPO₄ in order to inhibit Li from lacking in LiVOPO₄ obtained. By contrast, the first embodiment can yield LiVOPO₄ with high crystallinity without deficiency of Li even when [Li]/[V] is adjusted to 0.9 to 1.2 near the stoichiometric ratio of LiVOPO₄.

Preferably, before heating the mixture under pressure, the hydrothermal synthesis step of the first embodiment adjusts the pH of the mixture to less than 7. This makes it easier for a β-type crystal phase of LiVOPO₄ to occur, whereby the discharge capacity tends to improve remarkably.

For adjusting the pH of the mixture, various methods can be employed, an example of which is adding an acidic or alkaline reagent to the mixture. Examples of the acidic reagent include nitric acid, hydrochloric acid, and sulfuric acid. An example of the alkaline reagent is an aqueous ammonia solution. The pH of the mixture varies depending on the amount of the mixture and the species or compounding ratio of the lithium source, phosphate source, and vanadium source. Therefore, the amount of the acidic or alkaline reagent to be added may be adjusted according to the amount of the mixture and the species or compounding ratio of the lithium source, phosphate source, and vanadium source as appropriate.

The hydrothermal synthesis step heats the mixture while pressurizing it in a closed reaction vessel, so that a hydrothermal reaction proceeds in the mixture. This hydrothermally synthesizes LiVOPO₄ which is an active material.

The hydrothermal synthesis step of the first embodiment heats the mixture to 100 to 195° C. under pressure. The inventors infer that heating the mixture in a low-temperature region of 100 to 195° C. inhibits LiVOPO₄ from growing its crystal in excess. This, the inventors think, allows the first embodiment to yield LiVOPO₄ which has high crystallinity, excellent capacity density, nm-scale particle sizes, and high Li diffusability.

When the temperature of the mixture in the hydrothermal synthesis step is too low, the generation and crystal growth of LiVOPO₄ do not proceed sufficiently. As a result, LiVOPO₄ lowers its crystallinity, so as to reduce its capacity density, thereby making it harder to improve the discharge capacity of a battery using LiVOPO₄. When the temperature of the mixture is too high, on the other hand, the generation and crystal growth of LiVOPO₄ proceed so much that the Li diffusability in the crystal decreases. This makes it harder to improve the discharge capacity and rate characteristic of a battery using LiVOPO₄ obtained. Also, when the temperature of the mixture is too high, the reaction vessel is required to have high heat resistance, which increases the cost of manufacturing the active material. These tendencies can be suppressed when the temperature of the mixture falls within the range mentioned above.

Preferably, the pressure applied to the mixture in the hydrothermal synthesis step of the first embodiment is 0.2 to 1 MPa. When the pressure applied to the mixture is too low, finally obtained LiVOPO₄ tends to decrease its crystallinity, thereby reducing its capacity density. When the pressure applied to the mixture is too high, the reaction vessel is required to have high pressure resistance, which tends to increase the cost of manufacturing the active material. These tendencies can be suppressed when the pressure applied to the mixture falls within the range mentioned above.

Heat Treatment Step

The heat treatment step after the hydrothermal synthesis step heats the mixture. The heat treatment step can cause parts of the lithium source, phosphate source, and vanadium source which did not react in the hydrothermal synthesis step to react among them and promote the crystal growth of LiVOPO₄ generated in the hydrothermal synthesis step. This improves the capacity density of LiVOPO₄, thereby enhancing the discharge capacity of a battery using the same.

The heat treatment step of the first embodiment heats the mixture at a heat treatment temperature of 500 to 700° C. When the heat treatment temperature is too low, the crystal growth of LiVOPO₄ does not proceed sufficiently, whereby its capacity density is lowered. When the firing temperature is too high, LiVOPO₄ grows in excess, thereby increasing its particle size. As a result, the diffusion of lithium in the active material becomes slower, thereby lowering the capacity density of the active material. Because of the foregoing, the discharge capacity and rate characteristic of the battery are harder to improve when the heat treatment temperature is outside of the range mentioned above.

Preferably, the heat treatment time for the mixture is 3 to 20 hr. Preferably, the heat treatment atmosphere in the mixture is a nitrogen atmosphere, argon atmosphere, or air atmosphere.

The mixture obtained by the hydrothermal synthesis step may be preheated for about 1 to 30 hr at 60 to 150° C. before heating it in the heat treatment step. The preheating turns the mixture into a powder, thereby removing unnecessary moisture and organic solvent from the mixture. This can prevent LiVOPO₄ from incorporating impurities therein in the heat treatment step and homogenize the particle form.

LiVOPO₄ obtained by the above-mentioned first embodiment is suitable as a positive electrode active material of a lithium-ion secondary battery.

The lithium-ion secondary battery comprises a power generating element including planar negative and positive electrodes opposing each other and a planar separator arranged between and adjacent to the negative and positive electrodes, an electrolytic solution containing lithium ions, a case accommodating them in a closed state, a negative electrode lead having one end part electrically connected to the negative electrode and the other end part projecting out of the case, and a positive electrode lead having one end part electrically connected to the positive electrode and the other end part projecting out of the case.

The negative electrode has a negative electrode current collector and a negative electrode active material layer formed on the negative electrode current collector. The positive electrode has a positive electrode current collector and a positive electrode active material layer formed on the positive electrode current collector. The separator is located between the negative and positive electrode active material layers.

The positive electrode active material layer contains LiVOPO₄ obtained by the manufacturing method mentioned above.

The battery having LiVOPO₄ obtained by the manufacturing method in accordance with the first embodiment as its positive electrode active material can improve the discharge capacity as compared with a battery using LiVOPO₄ obtained by a conventional manufacturing method.

LiVOPO₄ has been known to exhibit a plurality of crystal structures such as triclinic crystal (α-type crystal) and rhombic crystal (β-type crystal) and have different electrochemical characteristics depending on their crystal structures.

The β-type crystal of LiVOPO₄ has an ion conduction path more linear and shorter than that of the α-type crystal and thus is excellent in reversibly inserting and desorbing lithium ions (hereinafter referred to as “reversibility” as the case may be). Therefore, a battery using the β-type crystal of LiVOPO₄ has greater charge/discharge capacity and superior rate characteristic than a battery using the α-type crystal.

The inventors infer that, since LiVOPO₄ obtained by the method of manufacturing an active material in accordance with the first embodiment has a single phase of the β-type crystal, a battery using the same improves its discharge capacity. In other words, the method of manufacturing an active material in accordance with the first embodiment makes it possible to produce the β-type crystal of LiVOPO₄ with a higher yield than that of the conventional manufacturing method.

Though a preferred embodiment of the method of manufacturing an active material in accordance with the first aspect has been explained in detail in the foregoing, the first aspect is not limited to the first embodiment.

For example, the hydrothermal synthesis step may add carbon particles to the mixture before heating. This can produce at least a part of LiVOPO₄ on surfaces of the carbon particles, so as to allow the carbon particles to carry LiVOPO₄. As a result, the electric conductivity of the resulting active material can be improved. Examples of materials constituting the carbon particles include carbon black (graphite) such as acetylene black, activated carbon, hard carbon, and soft carbon.

The active material of the first aspect can also be used as an electrode material for an electrochemical device other than lithium-ion secondary batteries. Examples of the electrochemical device include secondary batteries, other than the lithium-ion secondary batteries, such as lithium metal secondary batteries (using an electrode containing LiVOPO₄ obtained by the first aspect as a cathode and metallic lithium as an anode) and electrochemical capacitors such as lithium capacitors. These electrochemical devices can also be used for power supplies for self-propelled micromachines, IC cards, and the like and decentralized power supplies placed on or within printed boards.

In the following, the first aspect will be explained more specifically with reference to examples and comparative examples, but is not limited to the following Examples 1 to 13.

### Example 1

In the making of LiVOPO₄ in Example 1, a mixed liquid containing the following materials was prepared.

Lithium source: 8.48 g (0.20 mol) of LiOH.H₂O (having a molecular weight of 41.96 and a purity of 99 wt %, special grade, manufactured by Nacalai Tesque Inc.)

Phosphate source: 23.07 g (0.20 mol) of H₃PO₄ (having a molecular weight of 98.00 and a purity of 85 wt %, first grade, manufactured by Nacalai Tesque Inc.)

Vanadium source: 18.37 g (0.10 mol) of V₂O₅ (having a molecular weight of 181.88 and a purity of 99 wt %, special grade, manufactured by Nacalai Tesque Inc.)

Water: 200 g of distilled water (for HPLC (High Performance Liquid Chromatography) manufactured by Nacalai Tesque Inc.) with 30 g of distilled water separately used between a glass vessel and an autoclave

Reducing agent: 2.56 g (0.05 mol) of NH₂NH₂.H₂O (having a molecular weight of 50.06 and a purity of 98 wt %, special grade, manufactured by Nacalai Tesque Inc.)

As can be seen from the respective contents of the above-mentioned phosphate source and vanadium source, the ratio [P]/[V] of the number of moles of phosphorus [P] contained in the mixed liquid to the number of moles of vanadium [V] contained in the mixed liquid was adjusted to 1. As can be seen from the respective contents of the above-mentioned lithium source and vanadium source, the ratio [Li]/[V] of the number of moles of lithium [Li] contained in the mixed liquid to the number of moles of vanadium [V] contained in the mixed liquid was adjusted to 1. As can be seen from the content of the lithium source and the amount of distilled water, the concentration of Li⁺ in the mixed liquid was adjusted to 1.0 mol/L. The respective compounded amounts of the above-mentioned materials, when converted into LiVOPO₄ (having a molecular weight of 168.85), stoichiometrically correspond to a yield of about 33.78 g (0.2 mol) of LiVOPO₄.

The above-mentioned mixed liquid was prepared in the following procedure. First, 23.07 g of H₃PO₄ and 180 g of distilled water were put into a 500-mL Erlenmeyer flask and stirred with a magnetic stirrer. After adding 18.37 g of V₂O₅ into the flask, the stirring was continued for about 2.5 hr, whereupon a pasty yellowish orange liquid phase having flowability was obtained in the flask. While vigorously stirring the liquid phase, 2.56 g of hydrazine monohydrate (NH₂NH₂.H₂O) were added dropwise thereto. The liquid phase was continuously stirred for about 60 min after adding hydrazine monohydrate. Since the liquid phase was vigorously stirred, no bubbling was seen upon adding hydrazine monohydrate. As hydrazine monohydrate was added dropwise, the color of the liquid phase changed from yellowish orange to mustard and further to green. The pH of the liquid phase after adding hydrazine monohydrate dropwise thereto was 2 to 3. The liquid phase was kept in a green flowable paste state. To the liquid phase after the dropwise addition of hydrazine monohydrate and stirring, 8.48 g of LiOH.H₂O were added over about 10 min. The pH of the liquid phase immediately after the addition of LiOH.H₂O was 7 to 8. As LiOH.H₂O was added, the color of the liquid phase changed to bright green. Then, 20 g of distilled water were added to the liquid phase, whereby the above-mentioned mixed liquid was obtained.

Into a glass vessel of a 0.5-L, autoclave accommodating a 35-mm football-shaped rotator therein, 249.53 g of the mixed liquid containing materials corresponding to 98.8% of the yield of 33.78 g assumed at the time of compounding the materials were transferred. While closing the glass vessel and stirring the mixed liquid within the glass vessel with a high-power magnetic stirrer, the mixed liquid was started to be heated under predetermined PID control. The pressure within the closed glass vessel was raised upon heating. Thus, the hydrothermal synthesis step heated the mixed liquid in the glass vessel over 48 hr under pressure. The temperature within the glass vessel was held at 180° C. in the hydrothermal synthesis step. The pressure within the glass vessel was held at 0.89 MPa.

When the temperature within the glass vessel dropped to 14.6° C. after stopping heating, the mixed liquid was taken out from within the glass vessel. It took about 15 hr for the temperature within the glass vessel to drop to 14.6° C. after stopping heating. After the temperature dropped to 14.6° C., the inside of the glass vessel before opening it was under pressure of about 0.05 MPa under the influence of a gas generated by the reaction. The mixed liquid taken out from within the glass vessel was a dark green solution with a blue precipitate. The pH of the mixed liquid was 5 to 6 when measured with a pH test strip and thereafter became 4 as the test strip was left as it was. The glass vessel was left to stand still, and the supernatant was removed from within the vessel. Further, about 200 ml of distilled water were added into the vessel and stirred, so as to wash the inside of the vessel. Immediately thereafter, all of the dark green solution with the blue precipitate, the removed supernatant, and the distilled water used for washing the inside of the vessel were filtered under suction, so as to yield a liquid. It took a very long time for the suction filtration. Thereafter, the precipitate taken out by the suction filtration was washed with about 300 ml of acetone and then filtered under suction again. The residue remaining after the filtering was semidried and then transferred to a stainless Petri dish, on which it was dried for 22 hr at room temperature in a vacuum.

The foregoing hydrothermal synthesis step yielded 36.78 g of a brown solid from the above-mentioned mixed liquid. The weight of the brown solid, when converted into LiVOPO₄, was seen to correspond to 110.2% of the yield of 33.78 g of LiVOPO₄ assumed at the time of compounding the materials.

Of the dried brown solid, 5.00 g were put into an alumina crucible. Using a heating furnace, a heat treatment step of heating the solid within the alumina crucible was carried out. The heat treatment step heated the solid within the alumina crucible in an air atmosphere. The heat treatment step raised the temperature within the furnace from room temperature to 600° C. over 60 min, heated the solid within the alumina crucible at 600° C. for 4 hr, and then naturally cooled the heating furnace. This heat treatment step yielded 3.50 g of a green powder as the active material of Example 1. The residual ratio of solid in the heat treatment step was 70%. The active material of Example 1 contained particles having a primary particle size of 1 to 2 μm.

### Examples 2 to 13 and Comparative Examples 1 to 9

In Examples 2 to 13 and Comparative Examples 1 to 9, [Li]/[V] and [P]/[V] were adjusted to the values listed in Table 1. The compounds listed in Table 1 were used as reducing agents in Examples 2 to 13 and Comparative Examples 1 to 9. Comparative Example 6 used no reducing agent. The temperature within the glass vessel containing the mixed liquid in a closed state was held at the values listed in Table 1 in the respective hydrothermal synthesis steps of Examples 2 to 13 and Comparative Examples 1 to 9. In the heat treatment steps of Examples 2 to 13 and Comparative Examples 1 to 9, the solid within the alumina crucible was heated at the heat treatment temperatures listed in Table 1.

The active materials of Examples 2 to 13 and Comparative Examples 1 to 9 were obtained as in Example 1 except for the foregoing matters.

Measurement of Crystal Structure

As a result of Rietveld analysis according to powder X-ray diffraction (XRD), the active materials of Examples 2 to 13 and Comparative Examples 1 to 9 were seen to contain β-type crystal phases of LiVOPO₄.

Making of Evaluation Cells

The active material of Example 1 and a mixture of polyvinylidene fluoride (PVDF) and acetylene black as a binder were dispersed in N-methyl-2-pyrrolidone (NMP) acting as a solvent, so as to prepare a slurry. The slurry was prepared such that the active material, acetylene black, and PVDF had a weight ratio of 84:8:8 therein. This slurry was applied onto an aluminum foil serving as a current collector, dried, and extended under pressure, so as to yield an electrode (positive electrode) formed with an active material layer containing the active material of Example 1.

Then, thus obtained electrode and an Li foil as its counter electrode were mounted on each other with a separator made of a polyethylene microporous film interposed therebetween, so as to yield a multilayer body (matrix). This multilayer body was put into an aluminum-laminated pack, which was then sealed in a vacuum after a 1-M LiPF₆ solution as an electrolytic solution was injected therein, so as to make an evaluation cell of Example 1.

Evaluation cells singly using the respective active materials of Examples 2 to 13 and Comparative Examples 1 to 9 were made as in Example 1.

Measurement of Discharge Capacity

Using the evaluation cell of Example 1, the discharge capacity (in the unit of mAh/g) at a discharging rate of 0.01 C (a current value at which constant-current, constant-voltage charging at 25° C. completed in 100 hr) was measured. Table 1 lists the result of measurement. Using the evaluation cell of Example 1, the discharge capacity (in the unit of mAh/g) at a discharging rate of 0.1 C (a current value at which constant-current, constant-voltage charging at 25° C. completed in 10 hr) was also measured. Table 1 lists the result of measurement.

The discharge capacity in each of the evaluation cells of Examples 2 to 13 and Comparative Examples 1 to 9 was measured as in Example 1. Table 1 lists the results of measurement.

Evaluation of the Rate Characteristic

The rate characteristic (in the unit of %) of Example 1 was determined. The rate characteristic is the ratio of discharge capacity at 0.1 C when the discharge capacity at 0.01 C is taken as 100%. Table 1 lists the results. Greater rate characteristic is more preferred.

The rate characteristic in each of the evaluation cells of Examples 2 to 13 and Comparative Examples 1 to 9 was determined as in Example 1. Table 1 lists the results.

TABLE 1

| | | | | | Heat treatment | Evaluation cell | | |
|---|---|---|---|---|---|---|---|---|
| | | | | | step | Discharge | | |
| | Hydrothermal synthesis step | | | | Heat treatment | capacity | | Rate |
| | | | Reducing | Temp. | temp. | (mAh/g) | | characteristic |
| Table 1 | [Li]/[V] | [P]/[V] | agent | (° C.) | (° C.) | 0.01 C | 0.1 C | (%) |
| Example 1 | 1 | 1 | hydrazine | 180 | 600 | 153 | 149 | 97.4 |
| Example 2 | 1 | 1 | hydrazine | 110 | 600 | 133 | 118 | 88.7 |
| Example 3 | 1 | 1 | hydrazine | 130 | 600 | 143 | 133 | 93.0 |
| Example 4 | 1 | 1 | hydrazine | 150 | 600 | 146 | 138 | 94.5 |
| Example 5 | 1 | 1 | hydrazine | 190 | 600 | 151 | 147 | 97.4 |
| Example 6 | 1.2 | 1.2 | hydrazine | 180 | 600 | 147 | 143 | 97.3 |
| Example 7 | 0.95 | 0.95 | hydrazine | 180 | 600 | 141 | 133 | 94.3 |
| Example 8 | 0.95 | 0.95 | hydrazine | 180 | 600 | 141 | 133 | 94.3 |
| Example 9 | 1.2 | 1 | hydrazine | 180 | 600 | 138 | 127 | 92.0 |
| Example 10 | 1 | 1.2 | hydrazine | 180 | 600 | 136 | 128 | 94.1 |
| Example 11 | 1 | 1 | H₂O₂ | 180 | 600 | 139 | 127 | 91.4 |
| Example 12 | 1 | 1 | hydrazine | 180 | 500 | 146 | 139 | 95.2 |
| Example 13 | 1 | 1 | hydrazine | 180 | 650 | 148 | 135 | 91.2 |
| Comparative | 1 | 1 | hydrazine | 90 | 600 | 122 | 114 | 93.4 |
| Example 1 | | | | | | | | |
| Comparative | 1 | 1 | hydrazine | 200 | 600 | 131 | 101 | 77.1 |
| Example 2 | | | | | | | | |
| Comparative | 1 | 1 | hydrazine | 180 | 400 | 115 | 105 | 91.3 |
| Example 3 | | | | | | | | |
| Comparative | 2 | 2 | hydrazine | 180 | 600 | 132 | 117 | 88.6 |
| Example 4 | | | | | | | | |
| Comparative | 0.85 | 0.85 | hydrazine | 180 | 600 | 111 | 99 | 89.2 |
| Example 5 | | | | | | | | |
| Comparative | 1 | 1 | none | 180 | 600 | 56 | 33 | 58.9 |
| Example 6 | | | | | | | | |
| Comparative | 1 | 1 | hydrazine | 180 | 450 | 129 | 118 | 91.5 |
| Example 7 | | | | | | | | |
| Comparative | 1 | 1 | hydrazine | 180 | 750 | 112 | 101 | 90.2 |
| Example 8 | | | | | | | | |
| Comparative | 1 | 1.3 | hydrazine | 180 | 600 | 113 | 98 | 86.7 |
| Example 9 | | | | | | | | |

As clear from Table 1, Examples 1 to 13 yielded LiVOPO₄ by a manufacturing method comprising a hydrothermal synthesis step of heating a mixed liquid containing a lithium source, a phosphate source, a vanadium source, water, and a reducing agent to 100 to 195° C. under pressure and a heat treatment step of heating a solid formed from the mixed liquid by the hydrothermal synthesis step to 500 to 700° C. Examples 1 to 13 also adjusted [P]/[V] to 0.9 to 1.2.

The discharge capacity at 0.01 C of each of the evaluation cells using LiVOPO₄ obtained by Examples 1 to 13 was seen to be greater than that in any of the comparative examples. The discharge capacity at 0.1 C of each of the evaluation cells using LiVOPO₄ obtained by Examples 1 to 13 was seen to be not smaller than that in any of the comparative examples.

It is inferred from the foregoing that the yield of the β-type crystal of VOPO₄ in each of Examples 1 to 13 is higher than that in any of the comparative examples.

### Embodiment of Second Aspect

In the following, the method of manufacturing an active material in accordance with an embodiment of the second aspect will be explained. This embodiment of the second aspect will be referred to as “second embodiment” hereinafter. The second aspect is not limited to the second embodiment.

Hydrothermal Synthesis Step

The hydrothermal synthesis step initially puts a lithium source, a phosphate source, a vanadium source, water, and a reducing agent into a reaction vessel similar to that of the first embodiment, so as to prepare a mixture (aqueous solution) in which they are dispersed. The method of preparing the mixture may be the same as that of the first embodiment.

The lithium source, phosphate source, vanadium source, water, and reducing agent may be the same as those in the first embodiment.

Before heating the mixture under pressure, the hydrothermal synthesis step of the second embodiment adjusts the ratio [P]/[V] of the number of moles of phosphorus [P] contained in the mixture to the number of moles of vanadium [V] contained in the mixture to 0.9 to 1.5. A battery obtained when adjusting [P]/[V] to the outside of the numeric range of 0.9 to 1.5 is hard to improve the discharge capacity. [P]/[V] may be adjusted by the compounding ratio between the phosphate source and vanadium source contained in the mixture.

Before heating the mixture under pressure, the hydrothermal synthesis step of the second embodiment may adjust the ratio [Li]/[V] of the number of moles of lithium [Li] contained in the mixture to [V] to 0.9 to 1.5. Effects of the second aspect can also be obtained when [Li]/[V] is greater than 1.5, though. [Li]/[V] may be adjusted by the compounding ratio between the lithium source and vanadium source contained in the mixture.

It has been necessary for conventional methods of manufacturing LiVOPO₄ to adjust [Li]/[V] to a value (e.g., 9) greater than 1 which is a stoichiometric ratio of LiVOPO₄ in order to inhibit Li from lacking in LiVOPO₄ obtained. By contrast, the second embodiment can yield LiVOPO₄ with high crystallinity without deficiency of Li even when [Li]/[V] is adjusted to 0.9 to 1.5 near the stoichiometric ratio of LiVOPO₄.

Preferably, before heating the mixture under pressure, the hydrothermal synthesis step of the second embodiment adjusts the pH of the mixture to 7.5 or less. This makes it easier for a β-type crystal phase of LiVOPO₄ to occur, whereby the discharge capacity tends to improve remarkably.

The method of adjusting the pH of the mixture may be the same as that in the first embodiment.

The hydrothermal synthesis step heats the mixture while pressurizing it in a closed reaction vessel, so that a hydrothermal reaction proceeds in the mixture. This hydrothermally synthesizes LiVOPO₄ which is an active material.

The hydrothermal synthesis step of the first embodiment heats the mixture to 200 to 300° C. under pressure. When the temperature of the mixture is too low, the generation and crystal growth of LiVOPO₄ do not proceed sufficiently. As a result, LiVOPO₄ lowers its crystallinity, so as to reduce its capacity density, thereby making it harder to improve the discharge capacity of a battery using LiVOPO₄. When the temperature of the mixture is too high, on the other hand, the generation and crystal growth of LiVOPO₄ proceed so much that the Li diffusability in the crystal decreases. This makes it harder to improve the discharge capacity of a battery using LiVOPO₄ obtained. Also, when the temperature of the mixture is too high, the reaction vessel is required to have high heat resistance, which increases the cost of manufacturing the active material. These tendencies can be suppressed when the temperature of the mixture falls within the range mentioned above.

The pressure applied to the mixture in the hydrothermal synthesis step of the second embodiment is the same as that in the first embodiment.

Heat Treatment Step

Preferably, the second embodiment further comprises a heat treatment step of heating the mixture after the hydrothermal synthesis step. The heat treatment step can cause parts of the lithium source, phosphate source, and vanadium source which did not react in the hydrothermal synthesis step to react among them and promote the crystal growth of LiVOPO₄ generated in the hydrothermal synthesis step. This improves the capacity density of LiVOPO₄, thereby enhancing not only the discharge capacity but also the rate characteristic of a battery using the same. Since the hydrothermal synthesis step heats the mixture at a sufficiently high temperature in the hydrothermal synthesis step, effects of the second aspect can be exhibited without carrying out the heat treatment step after the hydrothermal synthesis step.

Preferably, the heat treatment temperature for the mixture in the heat treatment step of the second embodiment is 400 to 700° C. When the heat treatment temperature is too low, LiVOPO₄ tends to reduce its degree of crystal growth, thereby lowering its degree of improvement in capacity density. When the heat treatment temperature is too high, LiVOPO₄ tends to grow in excess, thereby increasing its particle size. This slows down the diffusion of lithium in the active material, thereby reducing the degree of improvement in its capacity density. These tendencies can be suppressed when the heat treatment temperature falls within the range mentioned above.

The heat treatment time for the mixture may be the same as that in the first embodiment. The heat treatment atmosphere for the mixture may be the same as that in the first embodiment.

The second embodiment may preheat the mixture obtained by the hydrothermal synthesis step before heating it in the heat treatment step as with the first embodiment.

LiVOPO₄ obtained by the above-mentioned second embodiment is suitable as a positive electrode active material of the above-mentioned lithium-ion secondary battery. That is, the positive electrode active material layer of the battery preferably contains LiVOPO₄ obtained by the manufacturing method of the second embodiment.

A battery having LiVOPO₄ obtained by the manufacturing method in accordance with the second embodiment as a positive electrode active material can improve the discharge capacity as compared with a battery using LiVOPO₄ obtained by a conventional method.

The inventors infer that, since LiVOPO₄ obtained by the method of manufacturing an active material in accordance with the second embodiment has a single phase of β-type crystal, a battery using the same improves its discharge capacity. In other words, the inventors think it possible for the method of manufacturing an active material in accordance with the second embodiment to produce the β-type crystal with a yield higher than that in the conventional manufacturing method.

In the following, the second aspect will be explained more specifically with reference to examples and comparative examples, but is not limited to the following Examples 101 to 121.

### Example 101

In the making of LiVOPO₄ in Example 101, a mixed liquid containing the following materials was prepared.

Lithium source: 8.48 g (0.20 mol) of LiOH.H₂O (having a molecular weight of 41.96 and a purity of 99 wt %, special grade, manufactured by Nacalai Tesque Inc.)

Phosphate source: 23.06 g (0.20 mol) of H₃PO₄ (having a molecular weight of 98.00 and a purity of 85 wt %, Cica first grade, manufactured by Kanto Chemical Co., Inc. and a purity of 85 wt %, first grade, manufactured by Nacalai Tesque Inc.)

Vanadium source: 18.37 g (0.10 mol) of V₂O₅ (having a molecular weight of 181.88 and a purity of 99 wt %, special grade, manufactured by Nacalai Tesque Inc.)

Water: 200 g of distilled water (for HPLC (High Performance Liquid Chromatography) manufactured by Nacalai Tesque Inc.) with 30 g of distilled water separately used between a glass vessel and an autoclave

Reducing agent: 2.58 g (0.05 mol) of NH₂NH₂.H₂O (having a molecular weight of 50.06 and a purity of 98 wt %, special grade, manufactured by Nacalai Tesque Inc.)

As can be seen from the respective contents of the above-mentioned phosphate source and vanadium source, the ratio [P]/[V] of the number of moles of phosphorus [P] contained in the mixed liquid to the number of moles of vanadium [V] contained in the mixed liquid was adjusted to 1. As can be seen from the respective contents of the above-mentioned lithium source and vanadium source, the ratio [Li]/[V] of the number of moles of lithium [Li] contained in the mixed liquid to the number of moles of vanadium [V] contained in the mixed liquid was adjusted to 1. As can be seen from the content of the lithium source and the amount of distilled water, the concentration of Li⁺ in the mixed liquid was adjusted to 1.0 mol/L. The respective compounded amounts of the above-mentioned materials, when converted into LiVOPO₄ (having a molecular weight of 168.85), stoichiometrically correspond to a yield of about 33.78 g (0.2 mol) of LiVOPO₄.

The above-mentioned mixed liquid was prepared in the following procedure. First, 23.06 g of H₃PO₄ and 180 g of distilled water were put into a 500-mL Erlenmeyer flask and stirred with a magnetic stirrer. After adding 18.37 g of V₂O₅ into the flask, the stirring was continued for about 2.5 hr, whereupon a yellowish orange suspension was obtained in the flask. While vigorously stirring the suspension, 2.58 g of hydrazine monohydrate (NH₂NH₂.H₂O) were added dropwise thereto. As hydrazine monohydrate was added dropwise, the color of the liquid phase changed from yellowish orange to dusty green. Since the liquid phase was vigorously stirred, no bubbling was seen upon adding hydrazine monohydrate. At the moment when the suspension had further continuously been stirred for 10 min, the suspension became a green flowable paste. The pH of this paste was 3. The suspension was continuously stirred for about 60 min after adding hydrazine monohydrate. The liquid phase of the suspension was kept in the state of a mustard-colored flowable paste. Subsequently, 8.48 g of LiOH.H₂O were added to the paste over about 10 min. The pH of the paste immediately after the addition of LiOH.H₂O was 7 to 8. Then, 20 g of distilled water were added to the paste, whereby the above-mentioned mixed liquid was obtained. The pH of thus obtained mixed liquid was 7.5.

Into a glass vessel of a 0.5-L autoclave accommodating a 35-mm football-shaped rotator, 248.41 g of the mixed liquid containing materials corresponding to 98.8% of the yield of 33.78 g assumed at the time of compounding the materials were transferred. While closing the glass vessel and stirring the mixed liquid within the glass vessel with a high-power magnetic stirrer, the mixed liquid was started to be heated under predetermined PID control. The pressure within the closed glass vessel was raised upon heating. Thus, the hydrothermal synthesis step heated the mixed liquid in the glass vessel over 48 hr under pressure. The temperature within the glass vessel was held at 250° C. in the hydrothermal synthesis step. The pressure within the glass vessel was held at 3.8 MPa.

When the temperature within the glass vessel dropped to 38° C. after stopping heating, the mixed liquid was taken out from within the glass vessel. It took about 2 hr for the temperature within the glass vessel to drop to 38° C. after stopping heating. The mixed liquid taken out from within the glass vessel was a clear and colorless solution with a brown precipitate. The pH of the mixed liquid was 6 when measured with a pH test strip. The glass vessel was left to stand still, and the supernatant was removed from within the vessel. Further, about 200 ml of distilled water were added into the vessel and stirred, so as to wash the inside of the vessel. Immediately thereafter, all of the clear and colorless solution with the brown precipitate, the removed supernatant, and the distilled water used for washing the inside of the vessel were filtered under suction, and the remaining precipitate was washed again with water, so as to yield a liquid. The pH of the liquid was 6 to 7. Then, the liquid was filtered under suction again. The brown precipitate contained in the liquid was washed with about 200 ml of acetone and then filtered under suction. The filtration left a very sticky paste. This paste was semidried and then transferred to a stainless Petri dish, on which it was dried for 15.5 hr at room temperature in a vacuum.

The foregoing hydrothermal synthesis step yielded 31.39 g of a brown solid as the active material of Example 101. The weight of the brown solid, when converted into LiVOPO₄, was seen to correspond to 94.4% of the yield of 33.78 g of LiVOPO₄ assumed at the time of compounding the materials.

### Example 102

Of a dried brown solid obtained by the same method as that of Example 101, 1.00 g was put into an alumina crucible. A heat treatment step of heating the solid within the alumina crucible for 4 hr at 450° C. in a heating furnace was carried out. The heat treatment step heated the solid within the alumina crucible in an Ar atmosphere. The heat treatment step raised the temperature within the furnace from room temperature to 450° C. over 45 min. After heating the solid within the alumina crucible at 450° C. for 4 hr, the heating furnace was naturally cooled. This heat treatment step yielded 1.00 g of a green powder as the active material of Example 102. Since the weight of solid did not change between before and after the heat treatment step, the residual ratio of solid in the heat treatment step was 100%.

### Examples 103 to 121

The compounds listed in Table 2 were used as lithium sources in Examples 103 to 121. [Li]/[V] and [P]/[V] in Examples 103 to 121 were adjusted to the values listed in Table 2. In the hydrothermal synthesis steps in Examples 103 to 121, the pH of the mixed liquid immediately before being heated in the autoclave took the values listed in Table 2. In Example 119, the pH of the mixed liquid was adjusted with an aqueous ammonia solution. In the hydrothermal synthesis steps in Examples 103 to 121, the temperature within the closed glass vessel containing the mixed liquid was held at the values listed in Table 2. In the heat treatment steps in Examples 103 to 121, the solid within the alumina crucible was heated in the atmospheres listed in Table 2. In Example 112, hydrogen peroxide was used in place of hydrazine as the reducing agent.

The active materials of Examples 103 to 121 were obtained as in Example 102 except for the foregoing matters.

### Comparative Example 101

The following materials were used for manufacturing LiVOPO₄ of Comparative Example 101.

Lithium source: 5.95 g (0.14 mol) of LiOH.H₂O (having a molecular weight of 41.96 and a purity of 99 wt %, special grade, manufactured by Nacalai Tesque Inc.)

Phosphate source: 5.42 g (0.047 mol) of H₃PO₄ (having a molecular weight of 98.00 and a purity of 85 wt %, first grade, manufactured by Nacalai Tesque Inc.)

Vanadium source: 1.43 g (0.0078 mol) of V₂O₅ (having a molecular weight of 181.88 and a purity of 99 wt %, special grade, manufactured by Nacalai Tesque Inc.)

Water: 200 g of distilled water (for HPLC (High Performance Liquid Chromatography) manufactured by Nacalai Tesque Inc.) with 30 g of distilled water separately used between a glass vessel and an autoclave

Reducing agent: 0.40 g (0.0080 mol) of NH₂NH₂.H₂O (having a molecular weight of 50.06 and a purity of 98 wt %, special grade, manufactured by Nacalai Tesque Inc.)

As can be seen from the respective contents of the above-mentioned phosphate source and vanadium source, [P]/[V] was adjusted to 3 in Comparative Example 101. As can be seen from the respective contents of the above-mentioned lithium source and vanadium source, [Li]/[V] was adjusted to 9. As can be seen from the content of the lithium source and the amount of distilled water, the concentration of Li⁺ in the mixed liquid was adjusted to 0.7 mol/L. The respective compounded amounts of the above-mentioned materials, when converted into LiVOPO₄ (having a molecular weight of 168.85), stoichiometrically correspond to a yield of about 2.63 g (0.0156 mol) of LiVOPO₄.

H₃PO₄ and the distilled water were put into a glass vessel of a 0.5-L autoclave and stirred with a magnetic stirrer. Then, V₂O₅ was added into the glass vessel, so as to yield a suspension. Further, while vigorously stirring the content of the glass vessel, hydrazine monohydrate was added dropwise to the suspension. At this moment, the liquid phase of the suspension changed its color from yellowish orange to green. Subsequent to the dropwise addition of hydrazine monohydrate, LiOH.H₂O was added to the suspension over about 10 min, so as to yield the mixed liquid of Comparative Example 101. The pH of the mixture immediately after adding LiOH.H₂O was 7.5, while its color was dark green.

While closing the glass vessel and beginning to stir the mixed liquid under predetermined settings, the mixed liquid was started to be heated under predetermined PID control. The pressure within the closed glass vessel was raised upon heating. Thus, the hydrothermal synthesis step heated the mixed liquid in the glass vessel over 48 hr under pressure. The temperature within the glass vessel was held at 250° C. in the hydrothermal synthesis step. The pressure within the glass vessel was held at 3.8 MPa.

After stopping heating, the glass vessel was started to be air-cooled. After the temperature within the glass vessel dropped to 25° C., the mixed liquid was taken out from within the glass vessel. It took about 2 hr for the temperature within the glass vessel to drop to 25° C. after stopping heating. The mixed liquid taken out from within the glass vessel was a navy-blue solution. The pH of the mixed liquid was 8. After adding 100 ml of distilled water to the mixed liquid three times, the mixed liquid was spilled over a tray. Then, the mixed liquid was dried for 24 hr at 100° C., so as to yield 7.48 g of a navy-blue solid.

The navy-blue solid was heat-treated as in Example 103, so as to yield the active material of Comparative Example 101.

### Comparative Examples 102 to 108

[Li]/[V] and [P]/[V] in Comparative Examples 102 to 108 were adjusted to the values listed in Table 2. In the hydrothermal synthesis steps in Comparative Examples 102 to 108, the pH of the mixed liquid immediately before being heated in the autoclave took the values listed in Table 2. In the hydrothermal synthesis steps in Comparative Examples 102 to 108, the temperature within the closed glass vessel containing the mixed liquid was held at the values listed in Table 2. In the heat treatment steps in Comparative Examples 102 to 108, the solid within the alumina crucible was heated in the atmospheres listed in Table 2. In Comparative Example 106, the active material was obtained without using any reducing agent.

The active materials of Comparative Examples 102 to 108 were obtained as in Comparative Example 101 except for the foregoing matters.

Measurement of Crystal Structure

As a result of Rietveld analysis according to powder X-ray diffraction (XRD), the active materials of Examples 101 to 121 and Comparative Examples 101 to 108 were seen to contain β-type crystal phases of LiVOPO₄.

Making of Evaluation Cells

The active material of Example 101 and a mixture of polyvinylidene fluoride (PVDF) and acetylene black as a binder were dispersed in N-methyl-2-pyrrolidone (NMP) acting as a solvent, so as to prepare a slurry. The slurry was prepared such that the active material, acetylene black, and PVDF had a weight ratio of 84:8:8 therein. This slurry was applied onto an aluminum foil serving as a current collector, dried, and extended under pressure, so as to yield an electrode (positive electrode) formed with an active material layer containing the active material of Example 101.

Then, thus obtained electrode and an Li foil as its counter electrode were mounted on each other with a separator made of a polyethylene microporous film interposed therebetween, so as to yield a multilayer body (matrix). This multilayer body was put into an aluminum-laminated pack, which was then sealed in a vacuum after a 1-M LiPF₆ solution as an electrolytic solution was injected therein, so as to make an evaluation cell of Example 101.

Evaluation cells singly using the respective active materials of Examples 102 to 121 and Comparative Examples 101 to 108 were made as in Example 101.

Measurement of Discharge Capacity

Using the evaluation cell of Example 101, the discharge capacity (in the unit of mAh/g) at a discharging rate of 0.01 C (a current value at which constant-current, constant-voltage charging at 25° C. completed in 100 hr) was measured. Table 2 lists the result of measurement. Using the evaluation cell of Example 101, the discharge capacity (in the unit of mAh/g) at a discharging rate of 0.1 C (a current value at which constant-current, constant-voltage charging at 25° C. completed in 10 hr) was also measured. Table 2 lists the result of measurement.

The discharge capacity in each of the evaluation cells of Examples 102 to 121 and Comparative Examples 101 to 108 was measured as in Example 101. Table 2 lists the results of measurement.

Evaluation of the Rate Characteristic

The rate characteristic (in the unit of %) of Example 101 was determined. The rate characteristic is the ratio of discharge capacity at 0.1 C when the discharge capacity at 0.01 C is taken as 100%. Table 2 lists the results. Greater rate characteristic is more preferred.

The rate characteristic in each of the evaluation cells of Examples 102 to 121 and Comparative Examples 101 to 108 was determined as in Example 101. Table 2 lists the results.

TABLE 2

| | | | | | | | | Evaluation cell | | |
|---|---|---|---|---|---|---|---|---|---|---|
| | | | | | | | | Discharge | | |
| | Hydrothermal synthesis step | | | | | | Heat | capacity | | Rate |
| | | | | Reducing | | Temp. | treatment | (mAh/g) | | characteristic |
| Table 2 | Li source | [Li]/[V] | [P]/[V] | agent | pH | (° C.) | temp. | 0.01 C | 0.1 C | (%) |
| Example 101 | LiOH | 1 | 1 | hydrazine | 7.5 | 250 | none | 137 | 100 | 73.0 |
| Example 102 | LiOH | 1 | 1 | hydrazine | 7.5 | 250 | Ar | 138 | 115 | 83.3 |
| Example 103 | LiOH | 1 | 1 | hydrazine | 7.5 | 250 | air | 132 | 127 | 96.2 |
| Example 104 | LiOH | 1 | 1 | hydrazine | 7.5 | 200 | air | 116 | 101 | 87.1 |
| Example 105 | LiOH | 1 | 1 | hydrazine | 7.5 | 215 | air | 122 | 103 | 84.4 |
| Example 106 | LiOH | 1 | 1 | hydrazine | 7.5 | 235 | air | 128 | 107 | 83.6 |
| Example 107 | LiOH | 1 | 1 | hydrazine | 7.5 | 270 | air | 133 | 110 | 82.7 |
| Example 108 | LiOH | 1 | 1 | hydrazine | 7.5 | 300 | air | 126 | 109 | 86.5 |
| Example 109 | LiOH | 1.1 | 1.1 | hydrazine | 7 | 250 | air | 125 | 112 | 89.6 |
| Example 110 | LiOH | 1.5 | 1.5 | hydrazine | 6 | 250 | air | 120 | 102 | 85.0 |
| Example 111 | LiOH | 0.95 | 0.95 | hydrazine | 7.5 | 250 | air | 123 | 108 | 87.8 |
| Example 112 | LiOH | 1 | 1 | H₂O₂ | 7.5 | 250 | air | 122 | 104 | 85.2 |
| Example 113 | Li₂CO₃ | 1 | 1 | hydrazine | 7.5 | 250 | air | 129 | 125 | 96.9 |
| Example 114 | CH₃COOLi | 1 | 1 | hydrazine | 4 | 250 | air | 127 | 120 | 94.5 |
| Example 115 | Li₃PO₄ | 1 | 1 | hydrazine | 4 | 250 | air | 127 | 122 | 96.1 |
| Example 116 | Li₂SO₄ | 1 | 1 | hydrazine | 3.5 | 250 | air | 116 | 99 | 85.3 |
| Example 117 | LiOH | 1 | 1.5 | hydrazine | 5 | 250 | air | 123 | 106 | 86.2 |
| Example 118 | LiOH | 1.5 | 1 | hydrazine | 7 | 250 | air | 125 | 104 | 83.2 |
| Example 119 | LiOH | 1 | 1 | hydrazine | 8 | 250 | air | 117 | 103 | 88.0 |
| Example 120 | LiOH | 0.9 | 1 | hydrazine | 7 | 250 | air | 118 | 104 | 88.1 |
| Example 121 | LiOH | 1 | 0.9 | hydrazine | 7 | 250 | air | 116 | 98 | 84.5 |
| Comparative Example 101 | LiOH | 9 | 3 | hydrazine | 7.5 | 250 | air | 31 | 12 | 38.7 |
| Comparative Example 102 | LiOH | 1 | 1 | hydrazine | 7.5 | 190 | air | 110 | 98 | 89.1 |
| Comparative Example 103 | LiOH | 1 | 1 | hydrazine | 7.5 | 320 | air | 115 | 97 | 84.3 |
| Comparative Example 104 | LiOH | 2 | 2 | hydrazine | 7 | 250 | air | 111 | 96 | 86.5 |
| Comparative Example 105 | LiOH | 0.8 | 0.8 | hydrazine | 7 | 250 | air | 112 | 97 | 86.6 |
| Comparative Example 106 | LiOH | 1 | 1 | none | 3 | 250 | air | 39 | 20 | 51.3 |
| Comparative Example 107 | LiOH | 1 | 1.7 | hydrazine | 6 | 250 | air | 108 | 95 | 88.0 |
| Comparative Example 108 | LiOH | 1 | 0.8 | hydrazine | 6 | 250 | air | 96 | 58 | 60.4 |

As clear from Table 2, Examples 101 to 121 yielded LiVOPO₄ by a manufacturing method comprising a hydrothermal synthesis step of heating a mixed liquid containing a lithium source, a phosphate source, a vanadium source, water, and a reducing agent to 200 to 300° C. Examples 101 to 121 also adjusted [P]/[V] to 0.9 to 1.5.

The discharge capacity at 0.01 C of each of the evaluation cells using LiVOPO₄ obtained by Examples 101 to 121 was seen to be greater than that in any of the comparative examples. The discharge capacity at 0.1 C of each of the evaluation cells using LiVOPO₄ obtained by Examples 101 to 121 was seen to be not smaller than that in any of the comparative examples.

It is inferred from the foregoing that the yield of the β-type crystal of LiVOPO₄ in each of Examples 101 to 121 is higher than that in any of Comparative Examples 101 to 108.

The discharge capacity and rate characteristic of Example 116 using Li₂SO₄ as a lithium source were seen to be lower than those of Examples 104 and 113 to 115 using lithium sources other than Li₂SO₄.

Comparisons of Example 101 with Examples 102 and 103 proved that the rate characteristic of evaluation cells using active materials obtained through the heat treatment step was greater than that in an evaluation cell using an active material obtained without the heat treatment step.

A comparison of Example 103 with Example 119 proved that the discharge capacity and rate characteristic of an evaluation cell improved when the pH of the mixed liquid immediately before heating with the autoclave in the hydrothermal synthesis step was 7.5 or lower.

What is claimed is:

1. A method of manufacturing an active material, the method comprising:
a hydrothermal synthesis step of heating a mixture containing a lithium source, a phosphate source, a vanadium source, water, and a reducing agent to 100 to 195° C. under pressure; and
a heat treatment step of heating the mixture to 500 to 700° C. after the hydrothermal synthesis step;
wherein the hydrothermal synthesis step adjusts the ratio [P]/[V] of the number of moles of phosphorus [P] contained in the mixture before heating to the number of moles of vanadium [V] contained in the mixture before heating to 0.9 to 1.2.

2. A method of manufacturing an active material according to claim 1, wherein the hydrothermal step adjusts the ratio [Li]/[V] of the number of moles of lithium [Li] contained in the mixture before heating to [V] to 0.9 to 1.2.

3. A method of manufacturing an active material according to claim 1, wherein the reducing agent is hydrazine.

4. A method of manufacturing an active material, the method comprising a hydrothermal synthesis step of heating a mixture containing a lithium source, a phosphate source, a vanadium source, water, and a reducing agent to 200 to 300° C. under pressure;
wherein the hydrothermal synthesis step adjusts the ratio [P]/[V] of the number of moles of phosphorus [P] contained in the mixture before heating to the number of moles of vanadium [V] contained in the mixture before heating to 0.9 to 1.5.

5. A method of manufacturing an active material according to claim 4, wherein the ratio [Li]/[V] of the number of moles of lithium [Li] contained in the mixture before heating to [V] is adjusted to 0.9 to 1.5.

6. A method of manufacturing an active material according to claim 4, wherein the lithium source is at least one species selected from the group consisting of LiOH, Li₂CO₃, CH₃COOLi, and Li₃PO₄.

7. A method of manufacturing an active material according to claim 4, further comprising a heat treatment step of heating the mixture after the hydrothermal synthesis step.
